(19) United States
(12) Patent Application Publication
(10) Pub. No.: US 2025/0354748 A1
(43) Pub. Date: Nov. 20, 2025

(54) REFRIGERATOR

(71) Applicant: LG ELECTRONICS INC., Seoul (KR)

(72) Inventors: Sunkook JI, Seoul (KR); Kiyoung LIM, Seoul (KR)

(73) Assignee: LG ELECTRONICS INC., Seoul (KR)

(21) Appl. No.: 19/209,063

(22) Filed: May 15, 2025

(30) Foreign Application Priority Data
May 16, 2024 (KR) 10-2024-0063817

(51) Int. Cl. F25D 23/02

(52) U.S. Cl. CPC F25D 23/028; F25D 2323/02; F25D 2700/04

(57) ABSTRACT

The present disclosure relates to a refrigerator, and the refrigerator includes a cabinet forming a storage space; a door opening and closing the storage space; and an opening device opening the door; in which the door includes a front panel forming a front surface of the door; a door liner forming a rear surface of the door; insulation filled between the front panel and the door liner; a handle recessed into the door; and a detection device provided in the door and detecting a user's hand within the handle to operate the opening device; and in which a detection device mounting part, which accommodates the detection device by forming a space separated from a space where the insulation is filled, and in which the detection device is positioned so as to face an inside of the handle, is formed on one side of the handle.

### CROSS-REFERENCE TO RELATED APPLICATIONS

The present application claims priority under 35 U.S.C. 119 of Korean Patent Application No. 10-2024-0063817, filed on May 16, 2024, in the Republic of Korea, which is hereby incorporated by reference in its entirety.

### BACKGROUND

The present disclosure relates to a refrigerator.

In general, a refrigerator is a home appliance that can store food at low temperatures in an internal storage space that is shielded by a door. To this end, the refrigerator is configured to cool the inside of the storage space by using cold air generated through heat exchange with a refrigerant that circulates a refrigeration cycle, thereby allowing the stored food to be stored in an optimal condition.

Recently, refrigerators are becoming larger and more multifunctional in line with the changing eating habits and the trend toward higher quality products, and refrigerators equipped with various structures and convenient devices for the convenience of users and efficient use of internal space are being released.

For example, a refrigerator equipped with an opening device that allows the door to open automatically is being developed. Accordingly, the user can easily open the heavy door with less force.

However, there is a problem that additional manipulation by the user is required for the reliable operation of the opening device, and the door must be opened after the manipulation.

In addition, if the component manipulated for the operation of the opening device is placed on the front surface of the door, there is a problem that the front surface of the door becomes contaminated when the user manipulates it. In particular, if the front surface of the door is formed of glass material or a material having a glossy or smooth surface to improve the outer appearance, there may be a problem that fingerprints or contaminants are left on it when the user manipulates it.

### SUMMARY

An object of the present disclosure is to provide a refrigerator whose door can be opened more easily.

An object of the present disclosure is to provide a refrigerator in which installation and maintenance of a detection device are easier.

An object of the present disclosure is to provide a refrigerator capable of preventing contamination of the front surface of the door.

A refrigerator according to an embodiment includes a cabinet forming a storage space; a door opening and closing the storage space; and an opening device opening the door; in which the door may be provided with a recessed handle, and a detection device detecting a user's hand may be provided inside the handle to operate the opening device.

A refrigerator according to an embodiment includes a cabinet forming a storage space; a door opening and closing the storage space; and an opening device opening the door; in which the door may include a panel assembly formed of a glass material and forming a front surface of the door; and a handle recessed into a peripheral surface of the door, and the handle may be provided with a detection device for detecting a user's hand to operate the opening device.

According to an embodiment, a refrigerator includes a cabinet forming a storage space; a door opening and closing the storage space; and an opening device opening the door; wherein the door includes: a front panel forming a front surface of the door; a door liner forming a rear surface of the door; an insulation filled between the front panel and the door liner; a handle recessed into a lower end of the door; and a detection device provided on the door, detecting a user's hand within the handle, and operating the opening device; and a detection device mounting part forming a space separated from a space where the insulation is filled may be formed on one side of the door in contact with the handle, the detection device mounting part may be spaced upward from a lower end of the door and surrounded by the insulation, and the detection device can be mounted within the detection device mounting part so as to face the inside of the handle.

The detection device mounting part may be positioned so that the outer surface including the lower side is surrounded by the insulation, spaced upward from the lower end of the door, and the detection device may be mounted so that it faces the inside of the handle.

The door may include a cap member forming a part of a peripheral surface of the door, and a handle opening which communicates with the handle and through which the detection device is exposed may be formed in the cap member.

The detection device mounting part may be formed on the door liner.

The detection device mounting part may be opened toward the rear and may be shielded by a liner cover mounted on the door liner.

The door liner may be formed with an opening device mounting part which opens rearward and in which the opening device is mounted, and the liner cover may shield the opening device mounting part and the detection device mounting part.

A boss may be formed on the detection device mounting part to which a screw for fixing the detection device is fastened, and the boss may extend toward the opening of the detection device mounting part.

The door liner may be formed with a handle accommodation part which accommodates the handle, and the detection device mounting part may communicate with the handle accommodation part and the handle opening.

The handle opening may be formed on one side of both left and right sides of the handle which is closer to a rotation axis of the door.

A locking member protruding for restraining the door may be mounted between the side of both left and right sides of the door that is farther from the rotation axis of the door and the handle.

The handle opening may be positioned closer to the upper end of the handle than to the lower end of the handle.

The upper end of the detection device may be arranged to be inclined toward the center of the handle rather than the lower end thereof.

The detection device is a proximity sensor including a light emitting part that irradiates light for detection toward the inside of the handle and a light receiving part that receives reflected light.

The detection device may be arranged to be inclined based on an inlet of the handle, and an extension line passing through the center of the light-emitting part may be arranged to pass between the inlet of the handle and the recessed end part of the handle.

One surface of the detection device exposed through the handle opening may have a slope intersecting with the inlet of the handle.

A refrigerator according to an embodiment includes a cabinet forming a storage space; a door opening and closing the storage space; and an opening device opening the door; in which the door may include a front panel forming a front surface of the door; a door liner forming a rear surface of the door; insulation filled between the front panel and the door liner; a handle recessed into the door; and a detection device provided in the door and detecting a user's hand within the handle to operate the opening device; in which a detection device mounting part, which accommodates the detection device by forming a space separated from a space where the insulation is filled and in which the detection device is positioned so as to face an inside of the handle, may be formed on one side of the handle.

The door may include a cap member which forms a part of the peripheral surface of the door and in which the handle is recessed, and the detection device mounting part may be formed on the recessed inner surface of the handle, so that the detection device is mounted on the inside of the handle.

The refrigerator may further include a detection device cover coupled with the detection device, in which the detection device cover may be mounted on the inside of the handle and form a part of the inner surface of the handle.

The detection device mounting part may be formed more recessed on one side of both left and right sides of the handle, farther from the rotation axis of the door.

The detection device may be composed of a touch sensor, and the detection device may be provided on the front surface of the recessed inner surface of the handle, which is closest to the front surface of the door.

The detection device mounting part may block the inflow of the insulation, and the detection device may be mounted while the insulation is filled inside the door by opening to the outside of the door.

The following effects can be expected from the refrigerator according to the proposed embodiment.

In a refrigerator according to an embodiment of the present disclosure, a detection device for detecting a user's hand is provided on one side of a handle, and the opening device is operated according to detection by the detection device, so that the door can be opened.

Accordingly, the user can easily open the door without performing a separate manipulation to open the door, thereby improving convenience of use.

In addition, the detection device can detect the user's hand even before the user actually grasps and pulls the handle. Accordingly, the door opens naturally before the user manipulates the handle, and the door can be opened more easily.

There is an advantage in that the door can be smoothly opened with a single motion of pulling the handle without any additional manipulation for automatic opening of the door, thereby further improving convenience of use.

In addition, the detection device is advantageous in that it is arranged obliquely on the inner side of the handle to more effectively detect the handle flowing into the handle and prevent false detection at other locations adjacent to the handle.

In addition, even if the front surface of the door is formed of a material such as glass or stainless steel that is easily contaminated with fingerprints or stains, the user does not need to perform any additional manipulation of the front surface of the door, so there is an advantage in that contamination of the front surface of the door is prevented and the outer appearance of the door is maintained clean.

In addition, the detection device mounting part where the detection device is mounted can be positioned independently of the space where the insulation is placed inside the door. Accordingly, even if the insulation is foamed into the door, the detection device will not be damaged by the foaming heat.

In addition, the detection device has a structure that can be detached from the door while the door is assembled, and thus has the advantage of easy assembly and installation of the detection device and easy maintenance.

### BRIEF DESCRIPTION OF THE DRAWINGS

FIG. 1 is a front view illustrating a refrigerator according to an embodiment of the present disclosure.

FIG. 2 is a perspective view illustrating the refrigerator with a part of the door open.

FIG. 3 is a front view illustrating the refrigerator with the door open.

FIG. 4 is a front view illustrating the door.

FIG. 5 is a rear view illustrating the door.

FIG. 6 is an exploded perspective view illustrating a state where each component of the door is exploded, as seen from the front.

FIG. 7 is an exploded perspective view illustrating a state where each component of the door is exploded, as seen from the rear.

FIG. 8 is a perspective view illustrating a lower cap, which is a component of the door.

FIG. 9 is an exploded perspective view illustrating the door with the opening device, detection device, and locking device separated from the door.

FIG. 10 is a partial perspective view illustrating the door as seen from below.

FIG. 11 is a partial rear view illustrating a state where the back cover of the door is separated.

FIG. 12 is a cross-sectional view taken along line 12-12 of FIG. 10.

FIG. 13 is a perspective view illustrating the detection device.

FIG. 14 is a view illustrating a state before and after installation of the detection device.

FIG. 15 is a view illustrating a state where a user's hand is detected.

FIG. 16 is a perspective view illustrating a refrigerator door according to a second embodiment of the present disclosure.

FIG. 17 is a top view illustrating the door.

FIG. 18 is an exploded perspective view illustrating a state where the detection device is separated from the door.

FIG. 19 is a cross-sectional view taken along line 19-19 of FIG. 17.

FIG. 20 is a front view illustrating a refrigerator according to a third embodiment of the present disclosure.

FIG. 21 is a bottom view illustrating the door of the refrigerator.

FIG. 22 is a view illustrating a state where the detection device is separated from the door.

FIG. 23 is a cross-sectional view taken along line 23-23 of FIG. 21.

FIG. 24 is a partial perspective view illustrating a refrigerator door according to a fourth embodiment of the present disclosure.

FIG. 25 is a view illustrating a state where a user's hand is detected.

FIG. 26 is a lower cross-sectional view illustrating the door.

### DETAILED DESCRIPTION OF THE EMBODIMENTS

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

Also, in describing components of embodiments of the present disclosure, terms such as first, second, A, B, (a), (b), or the like may be used. These terms are only intended to distinguish the components from other components, and the nature, order, or sequence of the components is not limited by the terms. When it is described that a component is “connected,” “coupled,” or “accessed” to another component, it should be understood that the component may be directly connected or accessed to the other component, but another component may also be “connected,” “coupled,” or “accessed” between each component.

In general, refrigerators can be divided into various types according to the divided form of the storage space and the arrangement and structure of the door. In the following, for the convenience of explanation and understanding, a refrigerator with the storage space divided into upper and lower parts will be described as an example, but the present disclosure is not limited thereto and can be applied to all types of refrigerators equipped with doors.

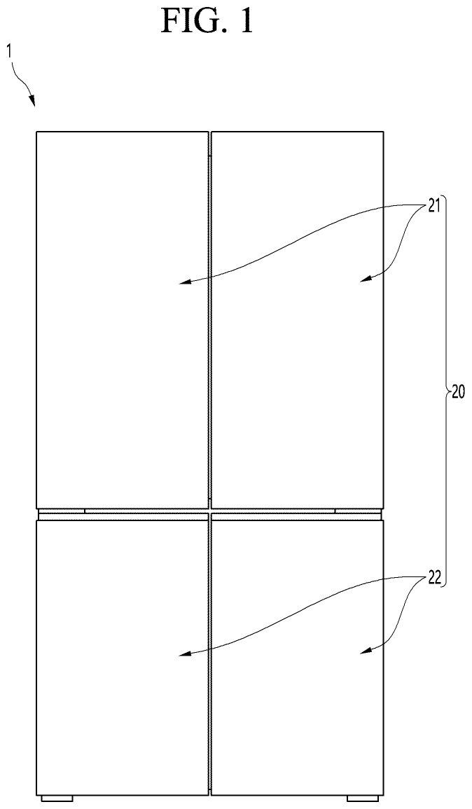

Before explanation, the direction is defined. In an embodiment of the present disclosure, the direction in which the front surface of the door as illustrated in FIG. 1 faces may be defined as a front direction, the direction toward the cabinet based on the front surface of the door may be defined as a rear direction, the direction toward the floor surface on which the refrigerator is installed may be defined as a lower direction, and the direction away from the floor surface may be defined as an upper direction.

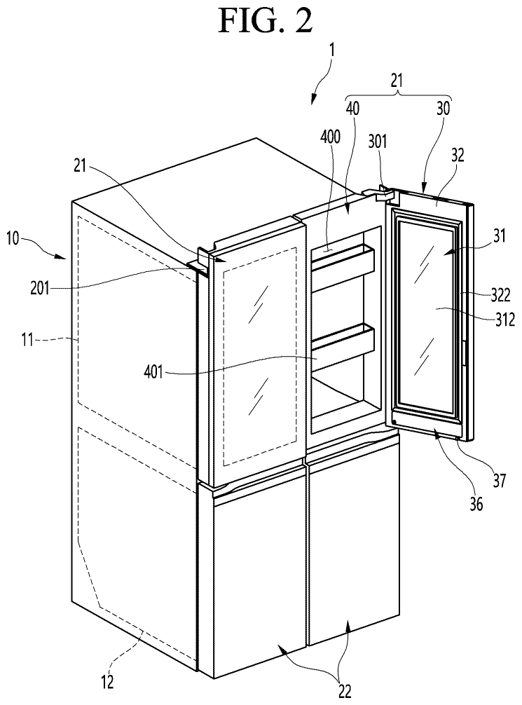

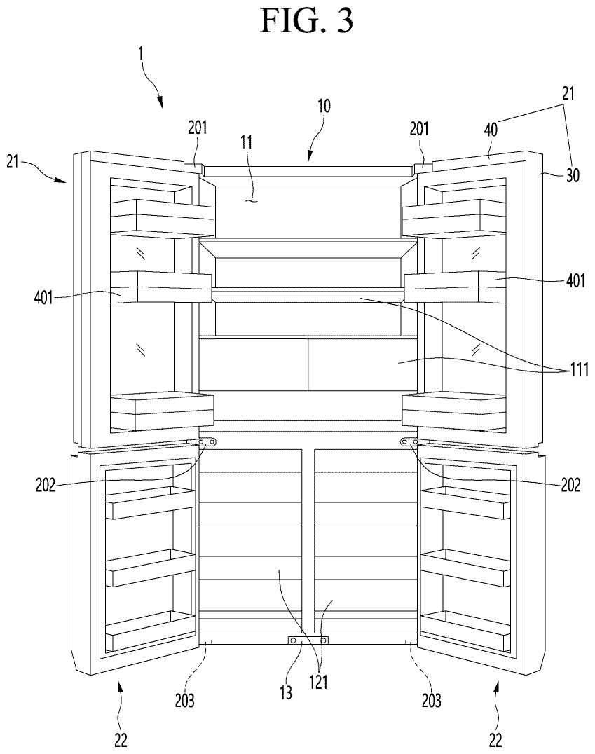

FIG. 1 is a front view illustrating a refrigerator according to an embodiment of the present disclosure, FIG. 2 is a perspective view illustrating the refrigerator with a part of the door open, and FIG. 3 is a front view illustrating the refrigerator with the door open.

As illustrated, the refrigerator 1 according to an embodiment of the present disclosure may have the overall outer appearance thereof formed by a cabinet 10 forming a storage space and a door 20 for opening and closing the cabinet 10.

The cabinet 10 can have the storage space divided to form an upper storage space 11 and a lower storage space 12 in the vertical direction. For example, the upper storage space 11 can be a refrigerating compartment, and the lower storage space can be a freezing compartment.

The door 20 may be configured to open and close the storage space, and may include an upper door 21 for opening and closing the upper storage space 11 and a lower door 22 for opening and closing the lower storage space 12.

The upper door 21 and lower door 22 can be arranged as a pair on each of both left and right sides, and can be configured to be opened and closed by rotation. In other words, the upper storage space 11 can be opened and closed by a pair of upper doors 21, and the lower storage space 12 can be opened and closed by a pair of lower doors 22.

The door 20 can be connected to the cabinet 10 by a hinge device 201, 202, 203 and can be rotated. For example, the upper end of the upper door 21 can be connected to the cabinet 10 by an upper hinge 201. In addition, the lower end of the upper door 21 and the upper end of the lower door 22 can be connected to the cabinet 10 by a middle hinge 202. In addition, the lower end of the lower door 22 can be connected to the cabinet 10 by a lower hinge 203.

In addition, at least one of the upper doors 21 may be formed as a double door structure (door in door structure) that is overlapped with each other. For example, the upper door 21 on the right side of the upper doors 21 may include a main door 40 that opens and closes the upper storage space 11 and a sub door 30 that rotates in the same direction as the main door 40 in front of the main door 40. Such a double door structure may also be provided on the left door of the upper doors 21 and the lower door 22.

An opening 400 may be formed in the main door 40. The opening 400 may penetrate the main door 40 in the front and rear direction, and may be formed to occupy most of the area except for the perimeter of the main door 40. In addition, the opening 400 may communicate with the interior of the upper storage space 11, and a separate storage device such as a door basket 401 may be provided in the opening 400.

In addition, the sub-door 30 is placed in front of the main door 40 and can be rotatably mounted on the main door 40. Therefore, the opening 400 can be opened and closed by the rotation of the sub-door 30.

To this end, the sub-door 30 and the main door 40 can be connected by a hinge 301. The sub-door 30 can be rotatably mounted on the main door 40 by the hinge 301. The hinge 301 can connect the upper end of the main door 40 and the upper end of the sub-door 30.

Meanwhile, the sub-door 30 may be equipped with an opening device 36 for opening and closing the sub-door 30. The opening device 36 may be operated by detecting user manipulation through a detection device 39 to be described below.

The sub-door 30 may be provided with a panel assembly 31 that allows the rear of the sub-door 30 to be seen through. In addition, the sub-door 30 may be provided with a gasket 322. The sub-door 30 may be provided with a locking device 37 that allows selective restraint of the sub-door 30.

Hereinafter, the structure of the sub-door 30 will be examined in more detail with reference to the drawings. In addition, the present disclosure can be applied to the upper door 21 of the single door structure, and can be applied to all doors in which a recessed handle 344 is formed. In addition, for the convenience of understanding and explanation, the following description will be based on the sub-door 30, and may be referred to as a door 30 or a door 20.

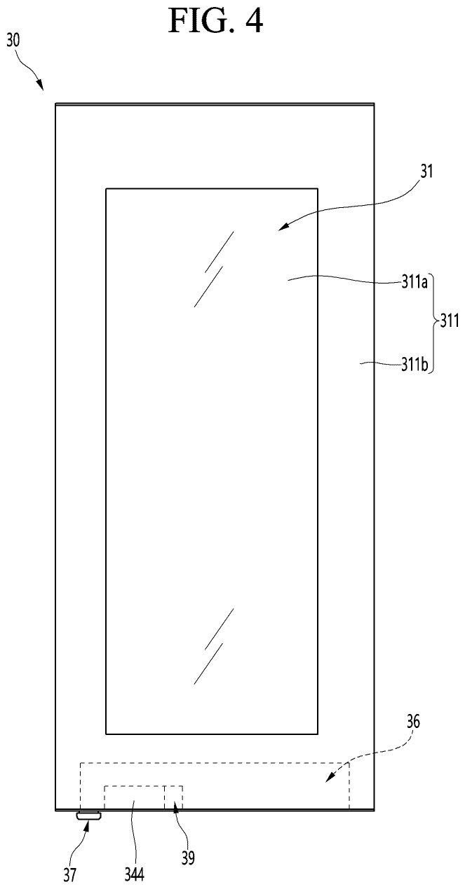

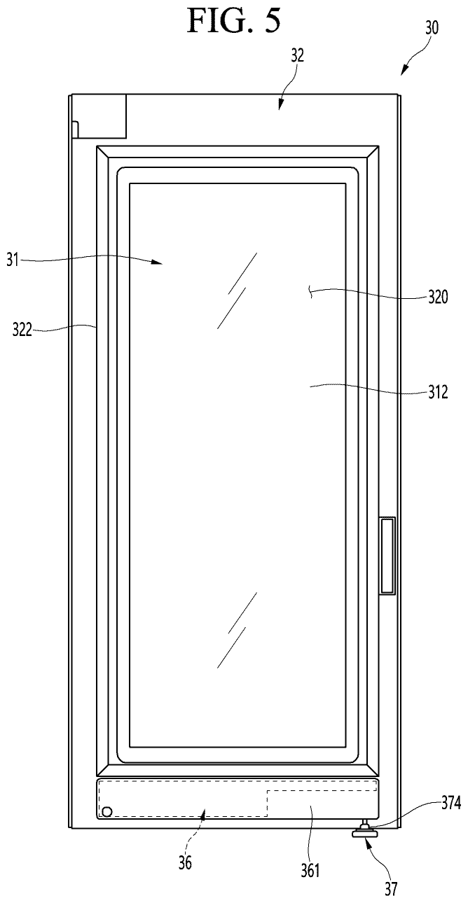

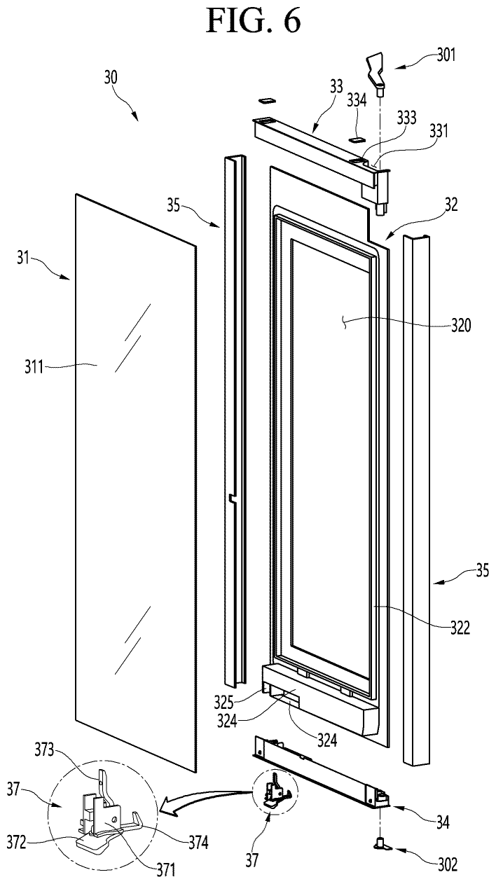

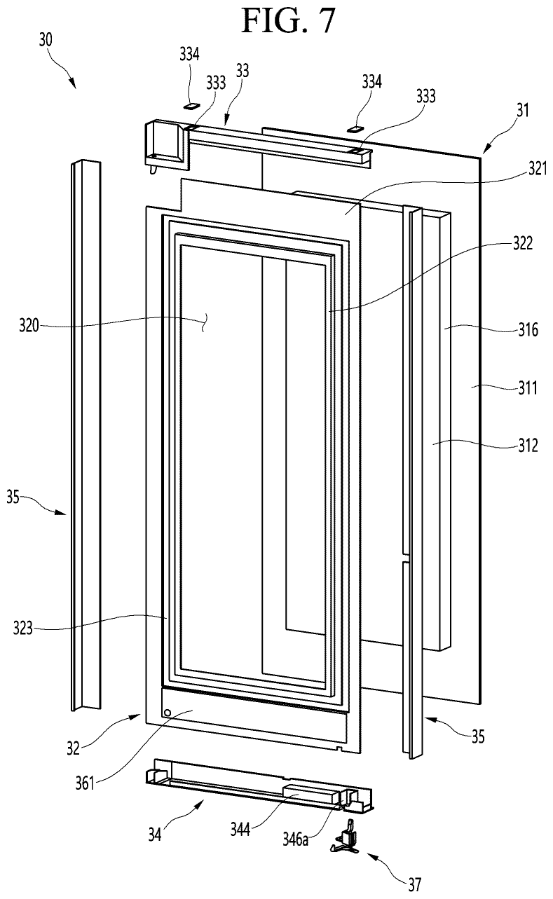

FIG. 4 is a front view illustrating the door, FIG. 5 is a rear view illustrating the door, FIG. 6 is an exploded perspective view illustrating a state where each component of the door is exploded, as seen from the front, and FIG. 7 is an exploded perspective view illustrating a state where each component of the door is exploded, as seen from the rear.

As illustrated, the door 30 may include a panel assembly 31 forming the front surface, a door liner 32 forming the rear surface, an upper cap 33 and a lower cap 34 forming the upper surface and a lower surface of the door 30. In addition, the door 30 may further include a side frame 35 forming both left and right sides.

In addition, the inside of the door 30 can be filled with insulation 300 (in FIG. 12). The insulation 300 can be filled between the panel assembly 31 and the door liner 32. For example, a foaming liquid can be injected into the inside of the space formed by the combination of the panel assembly 31, the door liner 32, the upper cap 33, the lower cap 34, and the side frame 35 to form the insulation 300.

The panel assembly 31 is formed of a glass material and can form the outer appearance of the front surface of the door 30. In addition, the entire front surface of the door 30 can be formed by the panel assembly 31. At this time, the front surface of the panel assembly 31 can be configured to have a set color pattern. In addition, the panel assembly 31 can include LEDs that emit light in various colors and express the entire color of the front surface of the door 30.

The panel assembly 31 can be composed of a plurality of panels 311, 312, and the insulation 300 can be filled in the space between the outer side of the panel assembly 31 and the outer surface of the door 20.

For example, the panel assembly 31 may include a front panel 311 formed of a tempered glass material. The front panel 311 may be formed of a material that allows light to pass through. The panel assembly 31 may further include a rear panel 312 provided at the rear of the front panel 311. The rear panel 312 may form a part of the rear surface of the door 30 and may shield a liner opening 320 formed in the door liner 32.

The front panel 311 and the rear panel 312 may be formed of a transparent material. For example, the front panel 311 and the rear panel 312 may be formed of a tempered glass or insulating glass material. Accordingly, the front panel 311 and the rear panel 312 may be formed to allow the rear space of the door 20 to be seen through. In other words, the panel assembly 31 is formed transparently so that the rear space of the door 20 can be seen through.

The panel assembly 31 is arranged along the perimeter of the front panel 311 and the rear panel 312 and may include a spacer 314 that forms an airtight space between the front panel 311 and the rear panel 312. In addition, an airtight insulating layer may be formed between the front panel 311 and the rear panel 312 by the spacer 314. For example, the insulating layer may be in a vacuum state or in a state where an insulating gas is injected.

The front panel 311 may be formed larger than the rear panel 312. For example, the front panel 311 may form the entire front surface of the door 20. The front panel 311 may include a see-through part 311a that sees through the space at the rear of the door, and a bezel part 311b formed along the perimeter of the see-through part 311a. The bezel part 311b may be formed opaquely, and may shield the components outside the see-through part 311a, including the spacer 314, the electrical wire 47 to be described below, and the PCB mounting part 38, from the front.

In addition, the rear panel 312 can be formed at a position away from the front panel 311 toward the rear, and can shield the liner opening 320 of the door liner 32. In addition, the space between the front panel 311 and the rear panel 312 can be formed by the spacer 314.

The door liner 32 may be formed of a plastic material. The door liner 32 may have a liner opening 320 formed in the center. The liner opening 320 may be shielded by the rear panel 312. The door liner 32 may form the rear surface of the door 30 and may form a surface between the outer side of the liner opening 320 and the perimeter of the door 30.

In addition, an opening device mounting part 323 on which an opening device 36 is mounted may be formed at the lower part of the door liner 32. The opening device mounting part 323 may be formed by recessing forward from the rear surface of the door liner 32 and may form a space in which the opening device 36 is accommodated.

In addition, the opening device 36 can be operated by the detection device 39 that detects the user's hand, and can be configured to open the door 30. The opening device 36 can be accommodated inside the opening device mounting part 323. In addition, the door liner 32 is provided with a rear cover 361, and the opening device 36 and the opening device mounting part 323 can be shielded by the rear cover 361.

The opening device 36 may be provided with a driving part, such as a motor that provides power inside, for example, and may be configured by a combination of a plurality of gears and/or links. In addition, the opening device 36 may be connected to the locking device 37, and power of the driving part may be transmitted to operate the locking device 37 that restrains the door 30. At this time, the operation of the driving part may be performed by detection by the detection device 39. The opening device 36 and the locking device 37 may have various structures that are connected to each other and can operate.

For example, the locking device 37 may be connected to the opening device 36. In addition, the locking device 37 may be provided at the lower end of the door 30. The locking device 37 may be located on one side of both left and right sides of the door 30 that is farther from the hinge axis.

The locking device 37 may include a case 371 provided on the door 30, a manipulation lever 372 rotatably mounted on the case 371, a hook 374 that is caught and restrained on the main door 40 or cabinet 10 by manipulation of the manipulation lever 372, and a lever connection part 373 connected to the opening device 36. Accordingly, the manipulation lever 372 is operated by operation of the opening device 36, and restraint of the hook 374 is released so that the door 30 can be opened.

The manipulation lever 372 may be exposed at the lower end of the door 30, and the remaining components may be placed inside the door 30. Accordingly, the user may also be able to release the restraint of the door 30 and open it by directly manipulating the manipulation lever 372.

The upper and lower ends of the door liner 32 and the front panel 311 can be connected by the upper cap 33 and the lower cap 34. A hinge can be coupled with one end of both left and right ends of the upper cap 33 and the lower cap 34, and the door 30 can be rotated about the hinge.

An injection port 333 may be formed in the upper cap 33. The injection port 333 is a hole for injecting a foam liquid forming insulation, and may be formed on at least one side of both left and right sides of the upper cap 33. In addition, the injection port 333 may be formed at a position corresponding to a space between the side of the door 30 and the panel assembly 31. Accordingly, the foam liquid injected through the upper cap 33 may effectively fill the perimeter of the panel assembly 31. In addition, an injection port cap 334 that shields the injection port 333 may be mounted on the upper cap 33.

The lower cap 34 may be formed with a locking device mounting part 346 on which the locking device 37 is mounted. In addition, a handle 342 may be recessed into the lower surface of the lower cap 34. The handle 342 may be arranged to be in contact with the locking device 37. In addition, the handle 344 may be formed on one side of both left and right sides of the door 30 that is farther from the rotational axis of the door 30. In other words, the handle 344 and the locking device mounting part 346 may be continuously arranged on one side of both left and right sides of the door 30 that is farther from the rotational axis of the door 30.

Meanwhile, a locking device accommodation part 325 recessed in at a position corresponding to the locking device mounting part 346 and the handle, and a handle accommodation part 324 may be formed at the lower part of the door liner 32. The locking device accommodation part 325 and the handle accommodation part 324 may be formed on one side of the opening device mounting part 323. In addition, when the rear cover 361 is mounted on the door liner 32, the opening device mounting part 323, the locking device accommodation part 325, and the handle accommodation part 324 may all be shielded.

When the lower cap 34 is mounted during assembly of the door 30, the locking device mounting part 346 and the handle 344 can be accommodated inside the locking device accommodation part 325 and the handle accommodation part 324. To this end, the locking device accommodation part 325 and the handle accommodation part 324 can be opened downward. In addition, the locking device accommodation part 325 and the handle accommodation part 324 can also be opened rearward.

In addition, both left and right sides of the door liner 32 and the front panel 311 can be connected by the side frame 35. With the door liner 32, upper cap 33, lower cap 34, side frame 35, and panel assembly 31 all assembled, the foaming liquid can be injected through the injection port 333 to form the insulation 300.

Meanwhile, the door 30 may be equipped with the detection device 39. In addition, at least a part of the detection device 39 may be positioned on the handle 344. Accordingly, when the user puts his/her hand into the handle 344 to open or close the door 30, the user's manipulation can be detected through the detection device 39.

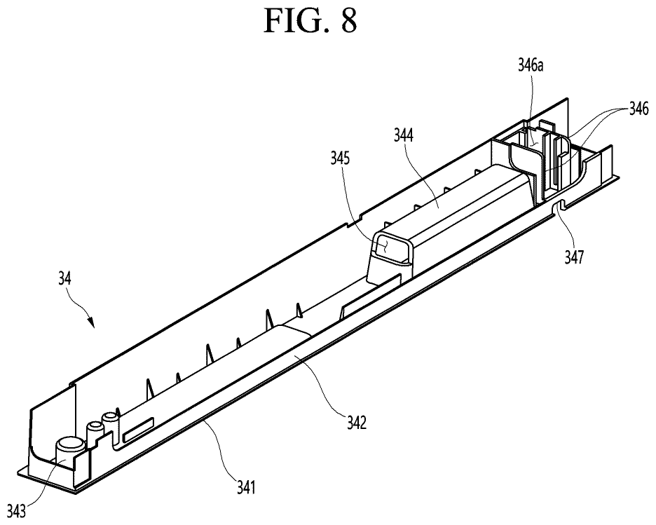

FIG. 8 is a perspective view illustrating a lower cap, which is a component of the door.

As illustrated, the lower cap 34 may include a lower surface 341 forming the lower surface of the door 30 and a peripheral surface 342 extending upward along the perimeter of the lower surface 341. The peripheral surface 342 may be coupled with the panel assembly 31 and the door liner 32. In addition, the peripheral surface 342 may be coupled with the side frame 35.

A hinge mounting part 343 on which a hinge 302 is mounted may be formed on the lower surface 341. The hinge mounting part 343 may be formed on one of both left and right sides of the lower cap 34. For example, the hinge mounting part 343 may be formed on the left end of the lower cap 34.

A locking device mounting part 346 may be formed on the lower surface 341. The locking device mounting part 346 may form a mounting space 346a penetrating the lower surface 341. In addition, the locking device mounting part 346 may fix the locking device 37 on both sides. The locking device 37 may be opened so that it may be accommodated in the mounting space 346a of the locking device mounting part 346. The locking device mounting part 346 may be formed on one side of both left and right sides of the lower cap 34 that is farther from the hinge mounting part 343. For example, the locking device mounting part 346 may be formed on the right end of the lower cap 34.

In addition, a hook groove 347 may be formed at the rear end of the lower surface 341 corresponding to the locking device mounting part 346 through which the hook 374 protrudes. With the locking device 37 mounted, the hook 374 may pass through the hook groove 347 and protrude rearward.

A handle 344 may be formed on the lower surface. The handle 344 is recessed upward from the lower surface, and a user can open and close the door 30 by inserting a hand therein. The handle 344 may be located on a side far from the rotational axis of the door 30 based on the center of the door 30. For example, the handle 344 may be located on the right side of the lower cap 34 and may be continuously arranged with the locking device mounting part 346. In addition, when the lower cap 34 is mounted, the handle 344 may be inserted into the handle accommodation part 324 of the door liner 32.

The handle 344 may be formed with a handle opening 345. The handle opening 345 may be formed on one side of both left and right sides of the handle 344. The handle opening 345 may be opened through the handle 344, and when the detection device 39 is mounted, a part of the detection device 39 may be exposed to the inside of the handle 344 through the handle opening 345.

The handle opening 345 may be formed on one side of the recessed inner surface of the handle 344 that is closer to the rotation axis of the door 30. For example, the handle opening 345 may be formed on the left side of the handle 344.

In addition, the handle opening 345 may be formed at an upper part of the side surface of the handle 344. In detail, the handle opening 345 may be positioned farther upward from the opened inlet of the handle 344. Accordingly, the detection device 39 may effectively detect the user's hand entering the handle 344 from the upper part of the side surface of the handle 344.

Below, the detection device 39 and related structure will be described in more detail with reference to the drawings.

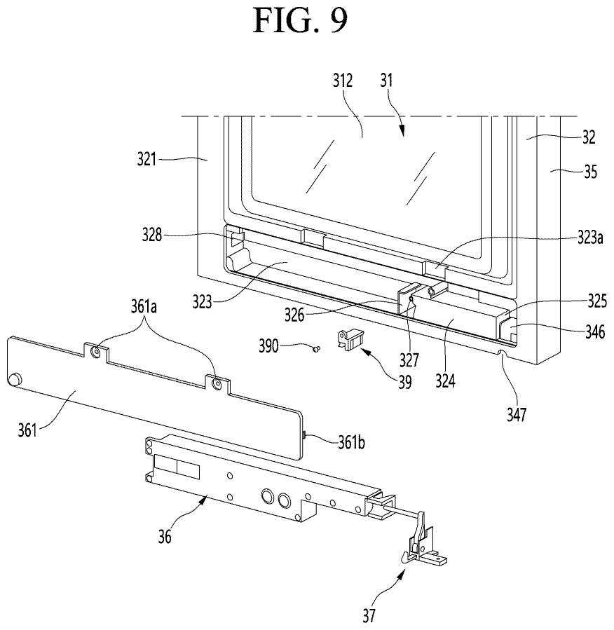

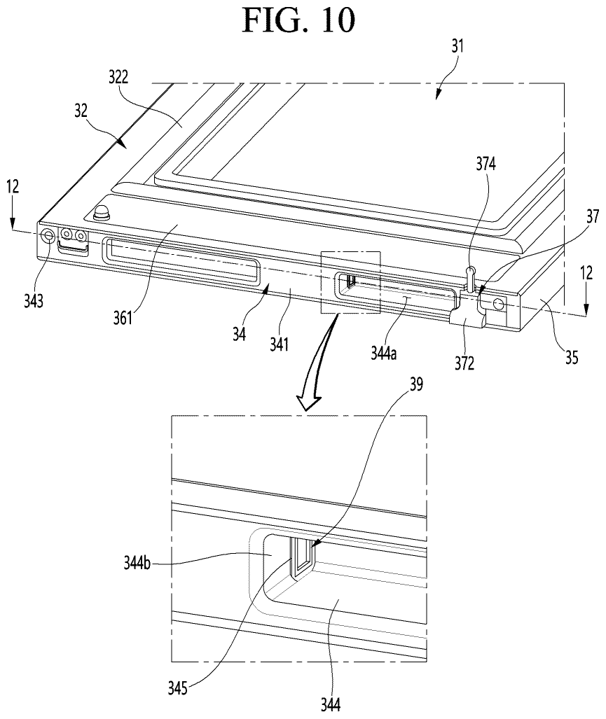

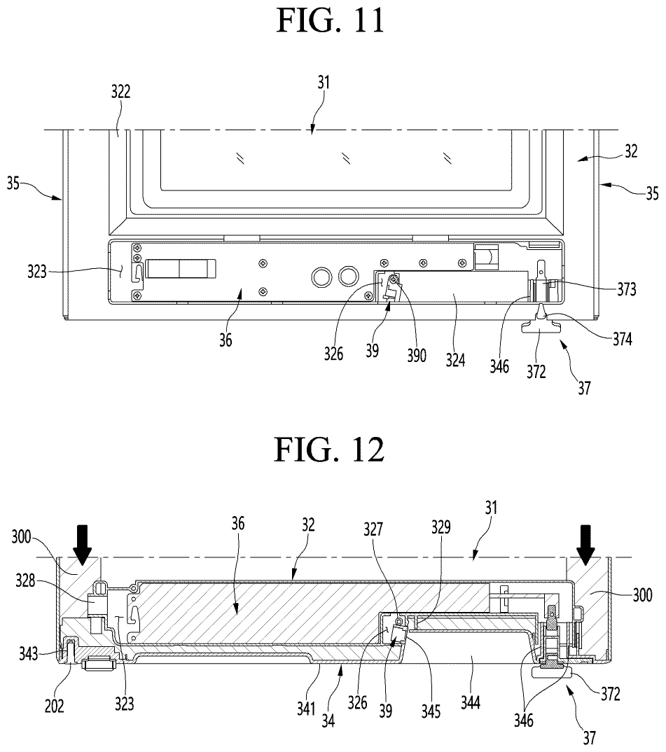

FIG. 9 is an exploded perspective view illustrating the door with the opening device, detection device, and locking device separated from the door, FIG. 10 is a partial perspective view illustrating the door as seen from below, FIG. 11 is a partial rear view illustrating a state where the back cover of the door is separated, and FIG. 12 is a cross-sectional view taken along line 12-12 of FIG. 10.

As illustrated, the opening device 36 may be mounted on the lower part of the door 30. The opening device 36 may be mounted on an opening device mounting part 323 recessed into the rear surface of the door 30.

In addition, a locking device accommodation part 325 in which the locking device 37 is mounted may be formed at the lower end of the door 30. In addition, the locking device 37 is connected to the opening device 36 within the locking device accommodation part 325. In addition, the locking device 37 may be configured to be operable by the opening device 36.

In addition, the handle accommodation part 324 may be formed on the side of the locking device accommodation part 325. The handle accommodation part 324 may be recessed in the opposite direction to the opening device mounting part 323. In other words, the handle accommodation part 324 may be opened in the inner direction of the door 30. In addition, insulation may be filled inside the handle accommodation part 324.

In detail, when the handle is placed in the handle accommodation part 324, foaming liquid may be injected to fill the insulation 300 between the inner surface of the handle accommodation part 324 and the outer surface of the handle 344. Accordingly, when a user holds the handle and opens and closes the door 30, the door 30 may be maintained in a firm state without wobbling due to the insulation 300 filled in the interior of the door 30.

A detection device mounting part 326 may be formed on the side of the handle accommodation part 324. The detection device mounting part 326 may be formed with the detection device 39 mounted thereon and may be formed on the door liner 32. In addition, the detection device mounting part 326 may be formed inside the opening device mounting part 323. In other words, the detection device mounting part 326 may be formed in a space separated from the space in which the insulation 300 is formed.

The detection device mounting part 326 can be positioned on the side of the handle accommodation part 324 and can come into contact with the handle accommodation part 324. Accordingly, the handle accommodation part 324 can be positioned between the detection device mounting part 326 and the locking device accommodation part 325.

The detection device mounting part 326 may be opened at the rear surface of the door 30 and may accommodate the detection device 39 therein. The detection device mounting part 326 may be shielded by the rear cover 361. The detection device 39 may also be shielded by the rear cover 361.

A boss 327 may be formed on the detection device mounting part 326. The boss 327 may extend to the rear where the detection device mounting part 326 is opened. In addition, a screw 390 for fixing the detection device 39 may be fastened to the boss 327.

The boss 327 may be positioned above the detection device mounting part 326. In addition, the boss 327 may be positioned higher than the handle opening 345. The boss 327 may be coupled with the upper end of the detection device 39, and may allow the detection device 39 to rotate during the mounting process of the detection device 39, thereby allowing the detection device 39 to be adjusted to incline at a set angle.

In addition, a communication hole 326b may be formed on one side of the detection device mounting part 326. The communication hole 326b may be formed at a position corresponding to the handle opening 345. In addition, the detection device mounting part 326 and the handle 344 may communicate by the communication hole 326b and the handle opening 345.

One side where the communication hole 326b is formed may be the detection device mounting part 326 or may be one side of the handle accommodation part 324. The detection device 39 may be exposed to the inside of the handle 344 through the handle opening 345 while mounted on the detection device mounting part 326.

At this time, the detection device 39 may be positioned so as to face from the upper side of one side of the handle 344 toward the lower side of the other side. In other words, the detection device 39 may be positioned at an angle based on the lower surface of the door 30, and thus, the user's hand inserted into the inside of the handle 344 may be effectively detected.

In addition, since the detection device 39 is positioned above and away from the lower end of the door 30, the insulation 300 can be filled up to the lower end of the door 30 below the detection device 39. In particular, by making the insulation 300 come into maximum contact with the outer surface of the handle 344, the door 30 can be maintained in a firm state when the user holds the handle 344.

Meanwhile, a blocking wall 329 extending downward may be further formed on the inner surface of the handle accommodation part 324. The blocking wall 329 may extend to the upper surface of the handle 344 and may be positioned on one side of both left and right sides of the upper surface of the handle 344 adjacent to the detection device mounting part 326. Accordingly, the insulation 300 formed to contact the outer surface of the handle 344 may be prevented from penetrating into the detection device mounting part 326.

The detection device 39 and opening device 36 can be shielded by the rear cover 361. When the rear cover 361 is opened, the detection device 39 may be detachable.

Therefore, after the molding of the insulation 300 is completed by injecting the high-temperature foam liquid, the detection device 39 can be mounted on the detection device mounting part 326 to prevent damage to the detection device 39. In addition, the rear cover 361 can be opened to enable simple replacement and maintenance of the detection device 39.

The rear cover 361 may further shield the opening device 36. Accordingly, the opening device 36 may be detached by opening the rear cover 361. In addition, the rear cover 361 may further shield the locking device 37. Accordingly, the opening device 36 and the locking device 37 may be connected while the rear cover 361 is open.

The opening device 36 and the locking device 37 are positioned within the recessed space formed in the door liner 32. Accordingly, a space independent of the space in which the insulation 300 is formed is formed, and the opening device 36 and the locking device 37 can be mounted while the insulation 300 is formed.

The cover fixing part 361a may be formed on the upper end of the rear cover 361. The cover fixing part 361a protrudes upward and may be coupled to a cover mounting part 323a formed on the rear cover 361. The rear cover 361 may be fixed to the rear surface of the door 30 by a screw 390 that penetrates and is fastened through the cover fixing part 361a and the cover mounting part 323a.

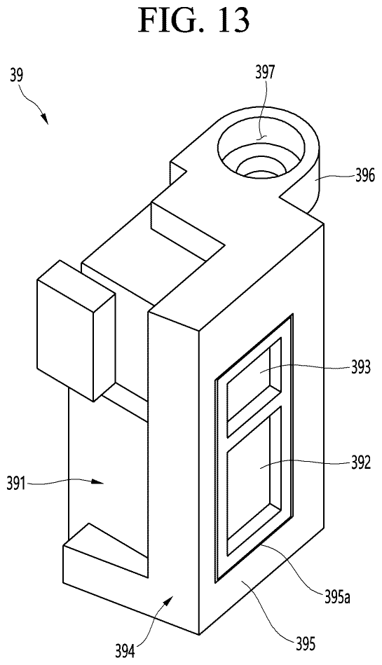

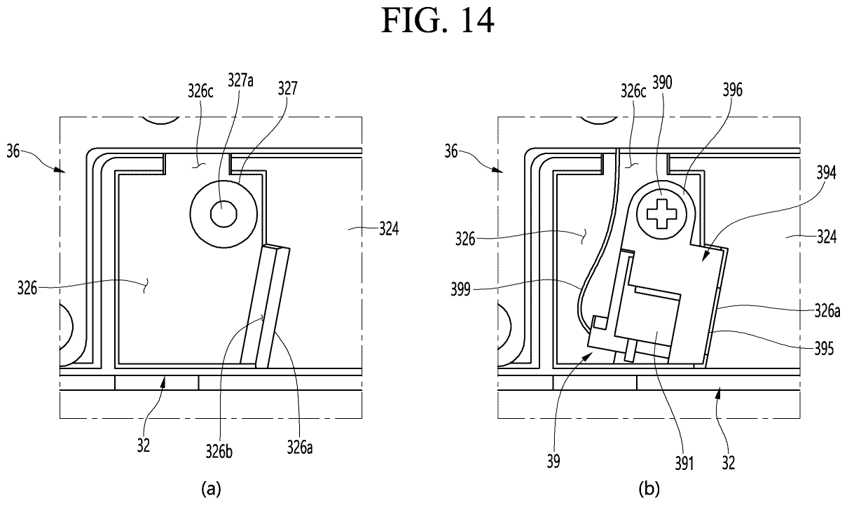

FIG. 13 is a perspective view illustrating the detection device. FIG. 14 is a view illustrating a state before and after installation of the detection device. FIG. 14(a) illustrates the appearance of the detection device mounting part 326 before the detection device 39 is mounted, and FIG. 14(b) illustrates the appearance of the detection device mounting part 326 with the detection device 39 mounted.

As illustrated, the detection device 39 can detect that the user's hand is inserted into the handle 344. The detection device 39 can detect the user's hand within the handle 344 in a non-contact manner. The detection device 39 can be composed of any one of a proximity sensor, an ultrasonic sensor, a vision sensor, and a camera.

For example, the detection device 39 may be configured as a proximity sensor, and more specifically, may be configured as a Position Sensitive Device (PSD) sensor. Of course, the detection device 39 may have various structures that detect the insertion of the user's hand into the handle 344.

The detection device 39 may include a detection device body 391 equipped with a light emitting part 393 and a light receiving part 392, and a detection device bracket 394 coupled with the detection device body 391.

The light emitting part 393 can irradiate light into the inside of the handle 344. In addition, the light receiving part 392 can detect the user's hand by receiving light reflected from the inside of the handle 344. The light emitting part 393 and the light receiving part 392 are arranged in a vertical direction and can be positioned on the same surface of the detection device body 391. In addition, the light emitting part 393 can be positioned further upward than the light receiving part 392. In other words, it can be arranged so as to irradiate light toward the inlet side of the handle 344 from a more recessed position of the handle 344.

The detection device bracket 394 can be fixedly mounted the detection device 39 to and on the detection device mounting part 326. A bracket opening 395a can be formed on the front surface 395 of the detection device bracket 394. In addition, the light-emitting part 393 and the light-receiving part 392 can be arranged in the bracket opening 395a. The bracket opening 395a can also be shielded by a material that allows light to pass through.

The front surface of the detection device bracket 394 can be formed to shield the front surface of the handle opening 345. Accordingly, when the detection device 39 is mounted on the detection device mounting part 326, the light emitting part 393 and the light receiving part 392 can be exposed to the recessed inside of the handle 344 through the handle opening 345.

A bracket coupling part 396 protruding laterally may be formed on the upper part of the detection device bracket 394. The bracket coupling part 396 may protrude so as to be seated above the boss 327. In addition, as illustrated in FIG. 14(a) and (b), a screw hole 237a, 397 to which a screw 390 is fastened may be formed on the upper ends of the bracket coupling part 396 and the boss 327. Accordingly, the detection device bracket 394 may be firmly fixed to the boss 327, and the detection device 39 may shield the handle opening 345 within the detection device mounting part 326.

Meanwhile, a communication hole 326b may be formed on one side of the detection device mounting part 326. In addition, a guide part 326a formed obliquely may be formed on one side of the detection device mounting part 326 where the communication hole 326b is formed. The guide part 326a may form one end of the communication hole 326b.

The guide part 326a may be formed stepwise based on one end of the communication hole 326b. Then, when the detection device 39 is fixed to the boss 327, the detection device 39 may be supported by being seated on the guide part 326a. In detail, the detection device bracket 394 may be seated and fixed on the guide part 326a. The shapes of the guide part 326a and the communication hole 326b may correspond to shapes that are coupled with the detection device. Therefore, as illustrated in FIG. 14(b), the detection device 39 may be aligned to an accurate position by the shapes of the guide part 326a and the communication hole 326b. Then, the detection device bracket 394 may be seated on the upper end of the boss 327.

Meanwhile, the guide part 326a may be formed to be inclined. The lower end of the guide part 326a may be positioned further from the handle 344 than the upper end of the guide part 326a. In other words, the guide part 326a may have an incline so that it gets closer to the handle 344 as it extends upward.

Accordingly, when the detection device 39 is positioned and secured on the guide part 326a, the detection device 39 can be mounted in an inclined state. At this time, the detection device 39 can be formed so that the surface exposed to the communication hole 326b and the handle opening 345 is inclined. One surface of the detection device 39 exposed through the handle opening 345 can be extended in a direction intersecting with the inlet of the handle 344 at a set slope.

In detail, the light emitting part 393 may protrude further toward the inside of the handle 344 than the light receiving part 392. Accordingly, light irradiated from the light emitting part 393 may irradiate toward the inlet of the handle 344, and effectively detect the user's hand.

An electrical wire guide 327a may be formed at the upper end of the detection device mounting part 326. The electrical wire guide 327a may be opened at the upper end of the detection device mounting part 326 to allow an electrical wire 399 connected to the detection device 39 to enter and exit. The electrical wire guide 327a may communicate with the inner side of the opening device mounting part 323. In addition, an electrical wire opening 328 may be formed at the opening device mounting part 323 through which an electrical wire connected to the detection device 39 and the door opening device is guided through the inside of the door 30.

Below, the operation of a refrigerator 1 according to an embodiment of the present disclosure having the structure will be described with reference to the drawings.

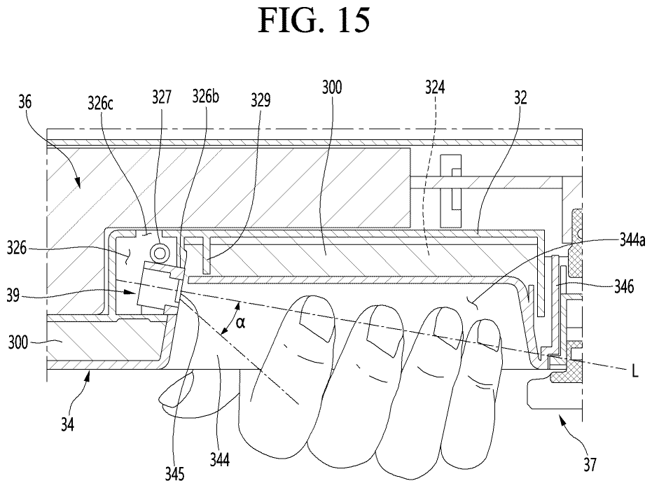

FIG. 15 is a view illustrating a state where a user's hand is detected.

As illustrated, a user can open the door 30 by holding the handle 344 and pulling the door 30. In detail, the user inserts his/her hand into the handle 344 to manipulate the handle 344. At this time, the detection device 39 can detect the user's hand before the user's hand holds and pulls the handle 344. In other words, the detection device 39 can detect the user's hand during the motion of the user attempting to hold the handle 344 with his/her hand.

The detection device 39 may be positioned at the upper part of one of both left and right sides of the handle 344. In other words, the detection device 39 may be positioned at a position farther upward from the inlet of the handle 344. In addition, the light emitting part 393 may irradiate light toward the lower part of the other of both left and right sides of the handle 344.

For example, the extension line L passing through the center of the light-emitting part 393 may be extended toward the lower part of the other side of both left and right sides of the handle 344. At this time, the extension line L may be positioned above the lower end of the handle 344, that is, above the inlet of the handle 344.

Since the detection device 39 is positioned away from the inlet of the handle 344, it is possible to prevent the user from misrecognizing when his or her hand manipulates a location other than the handle 344 adjacent to the handle 344. For example, when the user brings his or her hand to the upper end of the lower door 30 to open the lower door 30 below the door 30, the detection device 39 does not detect the user's hand.

In addition, the range α of the irradiation angle of the light-emitting part 393, i.e., the detection range, can be set to an angle of approximately 15° based on the extension line L. Accordingly, the irradiation angle of the light-emitting part 393 can include the inlet area of the handle 344.

Accordingly, the moment the user brings his/her hand to the handle 344, the light from the light emitting part 393 can be irradiated to the user's hand, and the reflected light is directed to the light receiving part 392 to detect the user's hand. In other words, the user's manipulation can be detected at the moment the user's hand is inserted into the handle 344 inlet before the user actually holds the handle 344.

In addition, when the detection device 39 detects the user's hand, the opening device 36 and the locking device 37 are operated to release the restraint of the door 30.

At this time, the detection of the detection device 39 and the operation of the opening device 36 can be performed in a very short time or substantially simultaneously. Therefore, the door 30 can start to open while the user places his/her hand on the handle 344 and holds the handle 344. In addition, the user can further rotate the opened door 30 while holding the handle 344 to open it.

In this way, since the door 30 is automatically released and opened at the moment of opening by the opening device 36, the user can open the door 30 without exerting force at the initial opening of the door 30. In addition, there is an advantage in that the door 30 can be automatically opened only by the general action of holding and pulling the handle 344 without any additional manipulation. Therefore, the user can easily open the door 30 without prior manipulation such as pressing or touching the front surface of the door 30.

Meanwhile, although the detection device 39 is arranged on one side of the handle 344, the detection device 39 can be arranged at a position sufficiently spaced upward from the lower end of the door 30. Accordingly, a sufficient space can be provided around the handle 344 to be filled with the insulation 300, and the strength of the adjacent part of the handle 344 that the user holds with his/her hand can be maintained despite the arrangement of the detection device 39.

Meanwhile, the present disclosure may have various other embodiments in addition to the embodiments described above. Other embodiments of the present disclosure may have the same configurations except for some configurations, and detailed descriptions or illustrations of the same configurations may be omitted. In addition, the same configurations may be indicated using the same drawing symbols.

Below, a description will be given focusing on configurations that are different from the embodiments of the present disclosure, and configurations that are not illustrated or omitted can be understood through the embodiments described above.

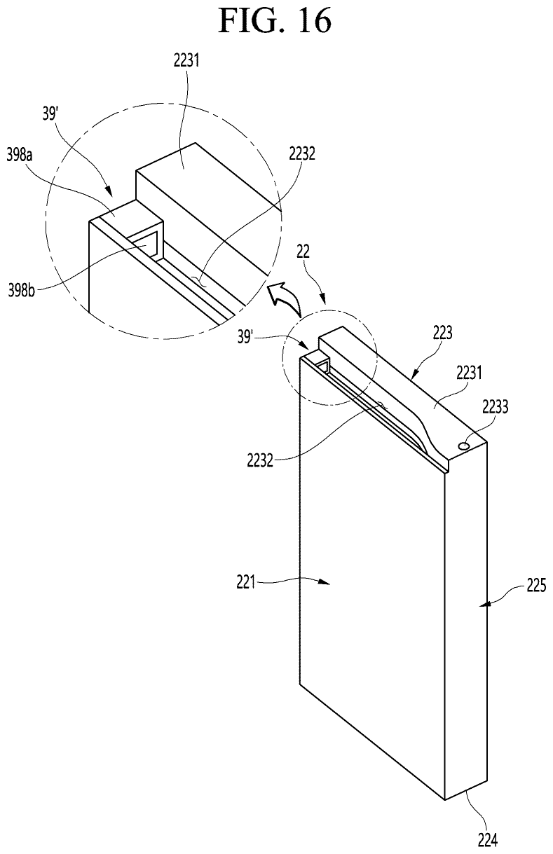

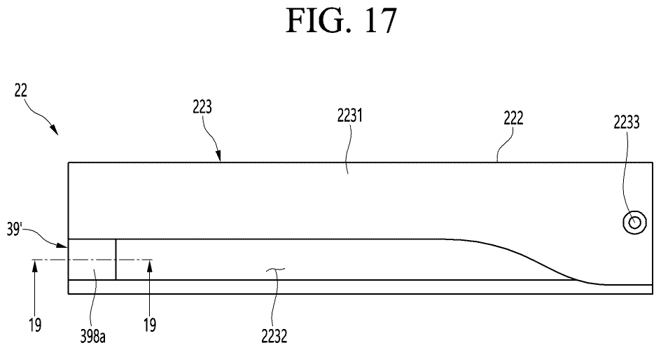

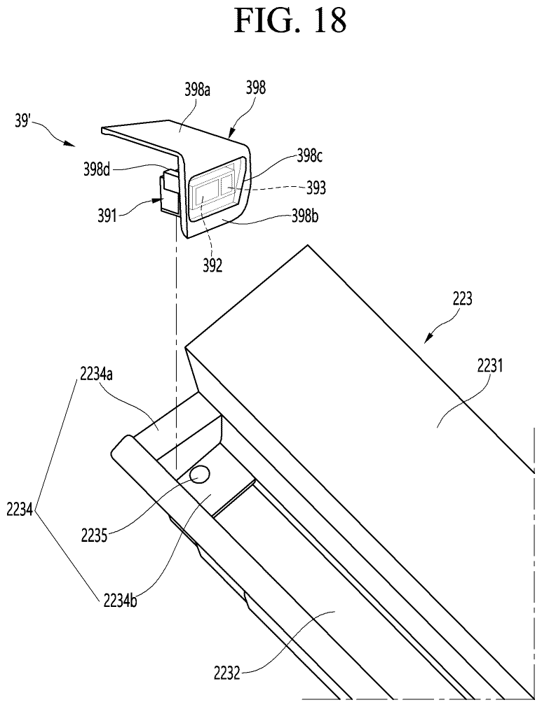

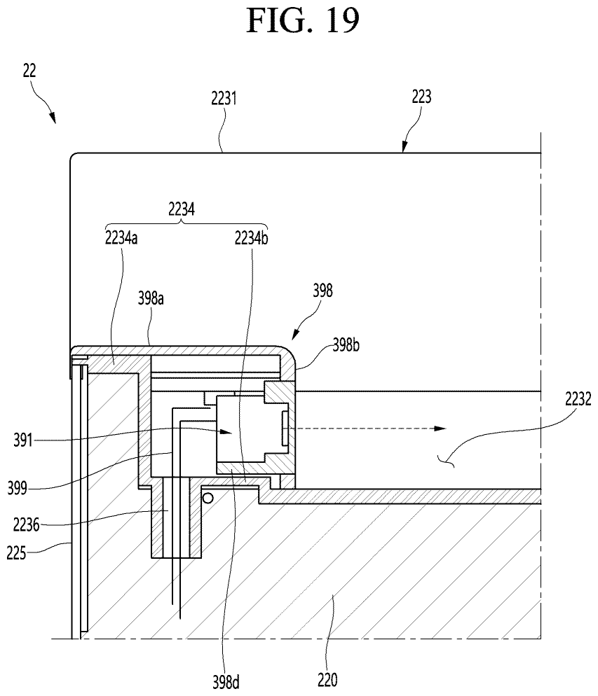

FIG. 16 is a perspective view illustrating a refrigerator door according to a second embodiment of the present disclosure, FIG. 17 is a top view illustrating the door, FIG. 18 is an exploded perspective view illustrating a state where the detection device is separated from the door, and FIG. 19 is a cross-sectional view taken along line 19-19 of FIG. 17.

As illustrated, the refrigerator 1 according to the second embodiment of the present disclosure may include a door 22 for opening and closing the storage space. The door 22 may be the lower door 22 of the first embodiment described above, and may be referred to as the door 22 hereinafter. In addition, unlike the door 20 of the first embodiment, the door 22 may be configured as a single door structure rather than a double door structure.

The door 22 may include a front panel 221 forming the front surface, a door liner 222 forming the rear surface, an upper cap 223 and a lower cap 224 forming the upper and lower surfaces of the door 22. In addition, the door 22 may include a side frame 225 forming both left and right sides. In addition, the interior of the door 22 may be filled with insulation 220.

The front panel 221 is intended to form the outer appearance of the front surface of the door 22, and may be formed of a glass material. In addition, the front panel 221 may be configured to have an RGB LED installed inside so that it appears in a set color. The front panel 221 may also be formed of a glossy metal or plastic material.

The upper cap 223 may include an upper surface 2231 forming the upper surface of the door 22. A hinge mounting part 2233 on which a hinge 202 for rotation of the door 22 is mounted may be formed on one of both left and right sides of the upper surface 2231.

In addition, a downwardly recessed handle 2232 may be formed at the front end of the upper cap 223. The front half part of the upper cap 223 where the handle 2232 is formed may be formed with a lower step than the rear half part thereof. In addition, the handle 2232 may be formed to be recessed downward at the front half part of the upper cap 223 so that a user may hold the handle 2232 with his or her hand.

The handle 2232 may be formed to extend from one end of both left and right sides of the upper cap 223 that is farther from the hinge mounting part 2233. In addition, a detection device mounting part 2234 may be formed on the inner side of the handle 2232, and the detection device 39′ may be mounted on the detection device mounting part 2234.

The detection device mounting part 2234 may be formed on one end of both left and right sides of the recessed inner surface of the handle 2232 that is farther from the hinge mounting part 2233. In addition, the detection device mounting part 2234 may be formed with a step downward on the inner surface of the handle 2232 so that the detection device 39′ may be seated thereon.

For example, the detection device mounting part 2234 may include a first seating part 2234a forming a side end part of the handle 2232, and a second seating part 2234b formed at a step from the lower end of the first seating part 2234a. The detection device 39′ may be seated on the first seating part 2234a and the second seating part 2234b and fixed to the inside of the handle 2232. Accordingly, the detection device 39′ may fill a part of the recessed space of the handle 2232 while being mounted on the detection device mounting part 2234.

In addition, an electrical wire guide part 327a may be formed in the detection device mounting part 2234. The electrical wire guide part 327a may be formed to penetrate the upper cap 223, and an electrical wire 399 connected to the detection device 39′ may be taken in and out.

The detection device 39′ may be any of a variety of other devices capable of detecting a user's hand approaching the handle 2232. For example, the detection device 39′ may be configured as a proximity sensor as in the embodiment described above.

The detection device 39′ may include a detection device body 391 equipped with a light-emitting part 393 and a light-receiving part 392, and a detection device cover 398 on which the detection device body 391 is fixedly mounted. The detection device cover 398 may include a first surface 398a forming an upper surface, and a second surface 398b extending downward from an end part of the first surface 398a to form a side surface.

On the second surface 398b, a penetration part 398c may be formed at a position corresponding to the light-emitting part 393 and the light-receiving part 392. The penetration part 398c may be open or may be shielded with a material that allows light to pass through.

The first surface 398a may be seated on the first seating part 2234a, and the second surface 398b may be seated on the second seating part 2234b. In addition, when the detection device 39′ is mounted, the first surface 398a and the second surface 398b may shield the recessed space of the handle 2232 and form a part of the handle 2232.

The detection device 39′ can be positioned so that the extension line of the center of the light-emitting part 393 faces the inner surface of the handle 2232 when mounted. In addition, the light-emitting part 393 is positioned at the upper end of the handle 2232, that is, lower than the inlet of the handle 2232, so as to detect the user's hand inserted into the handle 2232, and prevent misrecognition when the user's hand approaches at a different location adjacent to the handle 2232.

The detection device 39′ can instruct the operation of the opening device 13 for opening the door 22. The opening device 13 can be provided on the door 22 as in the embodiment described above. In addition, if necessary, the opening device can be provided on one side of the cabinet 10 facing the door 22.

For example, when the user's hand is detected by the detection device 39′, the opening device 13 provided in the cabinet 10 is operated to push and open the door.

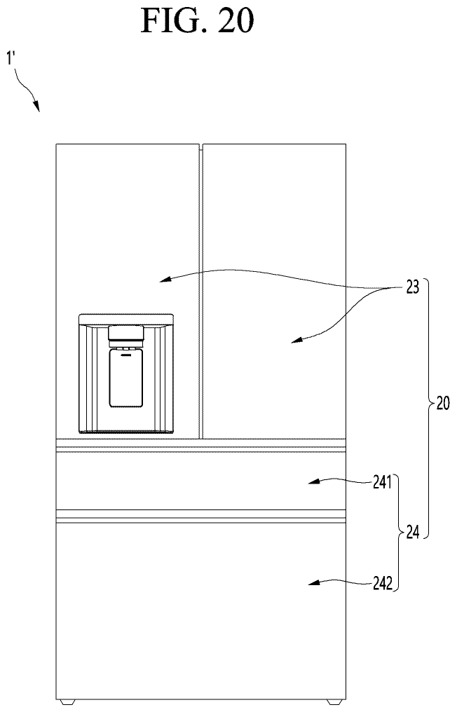

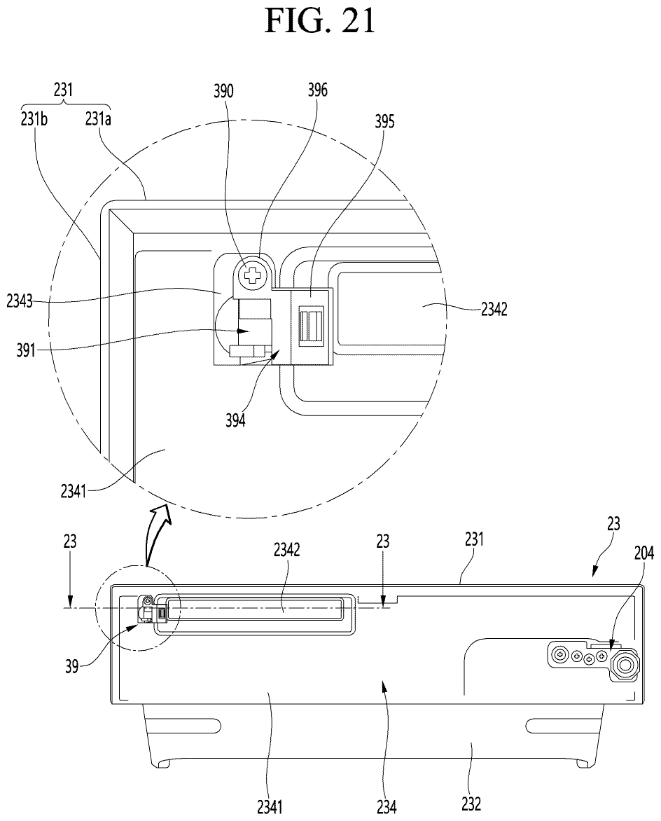

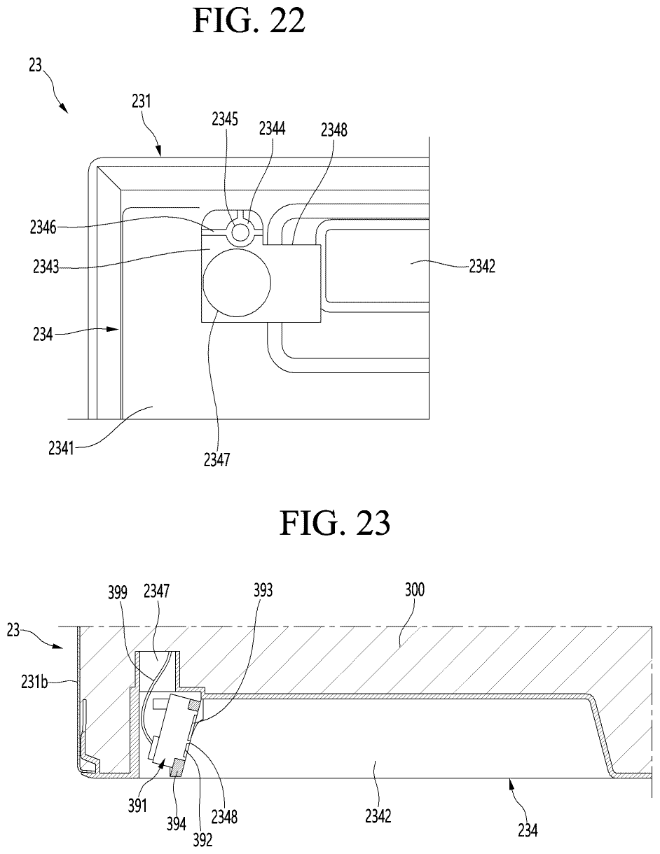

FIG. 20 is a front view illustrating a refrigerator according to a third embodiment of the present disclosure, FIG. 21 is a bottom view illustrating the door of the refrigerator, FIG. 22 is a view illustrating a state where the detection device is separated from the door, and

FIG. 23 is a cross-sectional view taken along line 23-23 of FIG. 21.

As illustrated, a refrigerator 1′ according to a third embodiment of the present disclosure may include a cabinet 10 forming a storage space and a door 20 for opening and closing the open front surface of the cabinet 10.

The door 20 may include an upper door 23 positioned upward and a lower door 24 positioned downward. For example, the upper doors 23 may be positioned in pairs on both left and right sides and may be rotated to open and close the upper storage space, respectively. The lower door 24 may be configured as a drawer and may be slid in and out in the front and rear direction to open and close the lower storage space. The lower doors 241, 242 may be positioned in pairs in the vertical direction and may be configured to be slid in and out, respectively.

In this embodiment, the structure of the upper door 23 is described in detail, and hereinafter, the upper door 23 may be referred to as a door 20. Of course, the structure of the present disclosure may also be applied to the lower door 24.

The door 20 may include an outer plate 231 forming the outer appearance of the front surface of the door 20, a door liner 232 forming the rear surface of the door 20, and an upper cap 233 and a lower cap 234 forming the upper and lower surfaces of the door 20.

For example, the outer plate 231 may be formed of a plate-shaped metal material and may be formed by bending. For example, the outer plate 231 may be formed of a stainless steel material having a smooth surface. The outer plate 231 may include a front part 231a forming the front surface of the door 20 and a side part 231b forming the side. In addition, insulation 300 may be formed inside the door 20 while the outer plate 231, the door liner 232, the upper cap 233, and the lower cap 234 are combined.

The lower cap 234 may be axially coupled with a hinge device 204. The hinge device 204 may support the door 20 from below and allow the door 20 to be rotatably mounted. The hinge device 204 may be formed on one end of both left and right ends of the lower cap 234.

A handle 2342 may be formed on the lower surface 2341 of the lower cap 234. The handle 2342 may be recessed into the lower surface of the lower cap 234. In addition, the handle 2342 may be formed on one side of both left and right sides of the lower cap 234 that is farther from the hinge device 204. Accordingly, a user may rotate the door 20 by putting his or her hand into the handle 2342.

The handle 2342 may be equipped with a detection device 39. The detection device 39 may be any of a variety of other devices capable of detecting a user's hand approaching the handle 2342. For example, the detection device 39 may be configured as a proximity sensor as in the embodiment described above.

The detection device 39 may include a detection device body 391 equipped with a light emitting part 393 and a light receiving part 392, and a detection device bracket 394 on which the detection device body 391 is fixedly mounted. A bracket coupling part 396 may be formed on the detection device bracket 394. A screw 390 is fastened to the bracket coupling part 396, and the detection device 39 may be fixedly mounted on the lower cap 234.

A detection device mounting part 2343 on which the detection device 39 is mounted may be formed on the lower cap 234. The detection device mounting part 2343 may be recessed into one side of the handle 2342.

In detail, the detection device mounting part 2343 may be formed to be recessed laterally at one end of the handle 2342. For example, the detection device mounting part 2343 may be formed at one end of both left and right sides of the handle 2342 that is farther from the hinge device 204.

The detection device mounting part 2343 may be recessed into a corresponding shape so that the detection device 39 may be accommodated. In addition, a handle opening 2348 may be formed on an open surface of the detection device mounting part 2343, that is, a surface that comes into contact with the handle 2342. The handle opening 2348 may be formed in a shape corresponding to a surface of the detection device 39 on which the light-emitting part 393 and the light-receiving part 392 are formed. In addition, the handle opening 2348 may be opened downward of the door 20.

When the detection device 39 is mounted, the detection device 39 can shield the handle opening 2348. In addition, the light-emitting part 393 and the light-receiving part 392 can be exposed to the inside of the handle 2342. Accordingly, the detection device 39 can detect the user's hand approaching the inside of the handle 2342.

In addition, the handle opening 2348 can be extended to the recessed upper end of the handle 2342. Accordingly, the detection device 39 can irradiate light from the upper end of one side of both left and right sides of the handle 2342, thereby effectively detecting the user's hand approaching the inside of the handle 2342 and preventing false detection at a location adjacent to the handle 2342.

Meanwhile, an electrical wire guide part 2347 may be formed in the detection device mounting part 2343. The electrical wire guide part 2347 may be formed by penetrating the lower cap 234, and an electrical wire 399 connected to the detection device 39 may be passed in and out.

In addition, a boss 2344 may be further formed on the detection device mounting part 2343. The boss 2344 may extend toward the opened lower surface of the detection device mounting part 2343. In addition, the boss 2344 may have a screw hole 2346 formed on which the bracket coupling part 396 may be secured and into which the screw 390 is fastened, so that the detection device 39 may be fixed.

The outer surface of the boss 2344 may be provided with a connection rib 2346 extending outwardly. The connection rib 2346 may connect the outer surface of the boss 2344 and the inner surface of the detection device mounting part 2343. The connection ribs 2346 are formed in multiple numbers to support the boss 2344 from multiple directions, and may ensure more stable mounting of the detection device 39.

Meanwhile, the side of the handle 2342 on which the detection device 39 is mounted and the handle opening 2348 may be formed to be inclined. In addition, when the detection device 39 is mounted, the surface on which the light-emitting part 393 and the light-receiving part 392 are formed may be formed to be inclined with respect to the inlet of the handle 2342.

At this time, the light emitting part 393 may protrude further into the handle 2342 than the light receiving part 392. Accordingly, light irradiated from the light emitting part 393 may be irradiated obliquely from the upper part of one side of the handle 2342 to the lower part of the opposite side. In addition, light irradiated from the light emitting part 393 may cross the handle 2342 in a diagonal direction.

When the detection device 39 detects that the user's hand is inserted into the handle 2342, the detection device 39 operates the opening device 36 to open the door 20. Then, the user can further rotate the door 20 while holding the handle 2342 to open the door.

Meanwhile, the hinge device 204 may have a structure for automatic opening of the door 20. In other words, when a detection signal from the detection device 39 is generated, the hinge device 204 may rotate to open the door 20. In other words, the hinge device 204 and the opening device may be configured as one piece. Of course, an opening device such as the embodiments described above may be provided on the door or cabinet 10 to open the door.

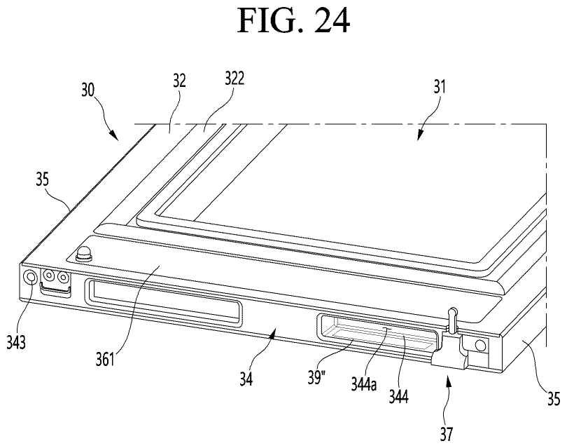

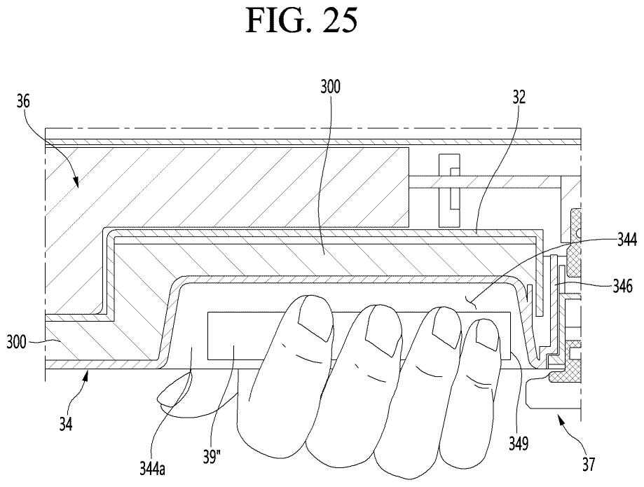

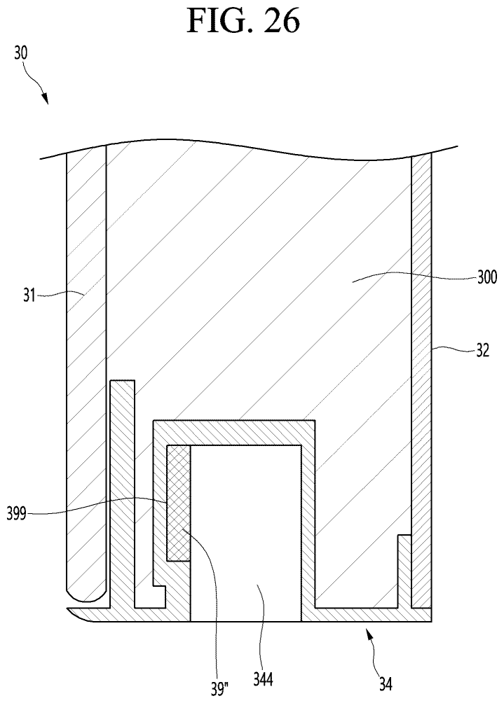

FIG. 24 is a partial perspective view illustrating a refrigerator door according to a fourth embodiment of the present disclosure, FIG. 25 is a view illustrating a state where a user's hand is detected, and FIG. 26 is a lower cross-sectional view illustrating the door.

As illustrated, a refrigerator door 30 according to a fourth embodiment of the present disclosure may include a panel assembly 31 forming a front surface, a door liner 32 forming a rear surface, an upper cap 33 and a lower cap 34 forming an upper surface and a lower surface. In addition, the door 30 may include a side frame 35 forming both left and right sides.

The panel assembly 31 may be configured to be made up of a plurality of transparent glass panels and configured to allow the rear of the door to be seen through. In addition, the door liner 32 may be provided with a gasket 322.

An opening device 36 and a locking device 37 may be provided at the lower part of the door 30. By the operation of the opening device 36, the locking device 37 can be selectively restrained and released the door 30. The opening device 36 may be mounted in an opening device mounting part 323 recessed into the door liner 32. In addition, the opening device mounting part 323 may be shielded by the rear cover 361.

A hinge mounting part 343 on which a hinge 302 is mounted may be formed on one side of both left and right sides of the lower cap 34. The door 30 may be rotatably mounted by the hinge 302.

In addition, a handle 344 may be formed recessed in the lower cap 34. The handle 344 may be formed on one side of both left and right sides of the door 30 that is farther from the hinge mounting part 343. In addition, a locking device 37 may be provided on the side adjacent to the handle 344.

The handle 344 can be placed on the inside of the handle accommodation part 324 recessed into the door liner 32. In addition, the perimeter of the handle 344 can be in contact with the insulation 300.

A detection device 39″ may be provided on one side of the handle 344. The detection device 39″ is configured as a contact detection sensor to detect when it comes into contact with the user's hand. For example, the detection device 39″ may be configured as a capacitance sensor, and may detect the approach or contact of the user's hand by a change in a magnetic field even if the user's hand does not make direct contact. Of course, the detection device 39″ may be configured as a piezoelectric element that detects a change in pressure when the user's hand makes contact.

In order to mount the detection device 39″, a detection device mounting part 349 may be formed on the handle 344. The detection device mounting part 349 may be recessed into one side of the handle 344, and the detection device 39″ may be fixedly mounted inside.

The detection device mounting part 349 can be further recessed into the inner surface of the recessed handle 344. Accordingly, when the detection device 39″ is mounted, the detection device 39″ can be exposed to the inner surface of the handle.

The detection device mounting part 349 may be formed on one inner side of the handle 344 adjacent to the front surface of the door 30. In detail, the detection device mounting part 349 may be formed on the front surface 344a of the inner surface of the handle 344. Accordingly, when a user puts his/her hand into the handle 344 and pulls the door 30, the user's hand may naturally come into contact with the detection device 39″.

What is claimed is:

1. A refrigerator comprising:
a cabinet forming a storage space;
a door opening and closing the storage space; and
an opening device opening the door;
wherein the door includes:
a front panel forming a front surface of the door;
a door liner forming a rear surface of the door;
insulation filled between the front panel and the door liner;
a recessed handle on the lower end of the door; and
a detection device provided on the door and detecting a user's hand within the handle to operate the opening device;
wherein a detection device mounting part forming a space separated from a space where the insulation is filled is formed on one side of the door that comes into contact with the handle, and
wherein the detection device mounting part is spaced upward from the lower end of the door and surrounded by the insulation, and
wherein the detection device is mounted within the detection device mounting part so as to face an inside of the handle.

2. The refrigerator of claim 1,
wherein the door includes a cap member forming a part of a peripheral surface of the door, and
wherein a handle opening which communicates with the handle and through which the detection device is exposed is formed in the cap member.

3. The refrigerator of claim 2,
wherein the detection device mounting part is formed on the door liner.

4. The refrigerator of claim 3,
wherein the detection device mounting part is opened toward the rear and is shielded by a liner cover mounted on the door liner.

5. The refrigerator of claim 4,
wherein the door liner is formed with an opening device mounting part which opens rearward and in which the opening device is mounted, and
wherein the liner cover shields the opening device mounting part and the detection device mounting part.

6. The refrigerator of claim 4,
wherein a boss is formed on the detection device mounting part to which a screw for fixing the detection device is fastened, and
wherein the boss extends toward the opening of the detection device mounting part.

7. The refrigerator of claim 3,
wherein the door liner is formed with a handle accommodation part which accommodates the handle, and
wherein the detection device mounting part communicates with the handle accommodation part and the handle opening.

8. The refrigerator of claim 2,
wherein the handle opening is formed on one side of both left and right sides of the handle which is closer to a rotation axis of the door.

9. The refrigerator of claim 8,
wherein a locking member protruding for restraining the door is mounted between the side of both left and right sides of the door that is farther from the rotation axis of the door and the handle.

10. The refrigerator of claim 2,
wherein the handle opening is positioned closer to the upper end of the handle than to the lower end of the handle.

11. The refrigerator of claim 10,
wherein the upper end of the detection device is arranged to be inclined toward the center of the handle rather than the lower end thereof.

12. The refrigerator of claim 2,
wherein the detection device is a proximity sensor including a light emitting part that irradiates light for detection toward the inside of the handle and a light receiving part that receives reflected light.

13. The refrigerator of claim 12,
wherein the detection device is arranged to be inclined based on an inlet of the handle, and
wherein an extension line passing through the center of the light-emitting part is arranged to pass between the inlet of the handle and the recessed end part of the handle.

14. The refrigerator of claim 2,
wherein one surface of the detection device exposed through the handle opening has a slope intersecting with the inlet of the handle.

15. A refrigerator comprising:
a cabinet forming a storage space;
a door opening and closing the storage space; and
an opening device opening the door;
wherein the door includes:
a front panel forming a front surface of the door;
a door liner forming a rear surface of the door;
insulation filled between the front panel and the door liner;
a handle recessed into the door; and
a detection device provided in the door and detecting a user's hand within the handle to operate the opening device; and
wherein a detection device mounting part, which accommodates the detection device by forming a space separated from a space where the insulation is filled, and in which the detection device is positioned so as to face an inside of the handle, is formed on one side of the handle.

16. The refrigerator of claim 15,
wherein the door includes a cap member which forms a part of the peripheral surface of the door and in which the handle is recessed, and
wherein the detection device mounting part is formed on the recessed inner surface of the handle, so that the detection device is mounted on the inside of the handle.

17. The refrigerator of claim 16, further comprising:
a detection device cover coupled with the detection device, wherein the detection device cover is mounted on the inside of the handle and forms a part of the inner surface of the handle.

18. The refrigerator of claim 16,
wherein the detection device mounting part is formed more recessed on one side of both left and right sides of the handle, farther from the rotation axis of the door.

19. The refrigerator of claim 15,
wherein the detection device is composed of a touch sensor, and
wherein the detection device is provided on the front surface of the recessed inner surface of the handle, which is closest to the front surface of the door.

20. The refrigerator of claim 15,
wherein the detection device mounting part blocks the inflow of the insulation, and
wherein the detection device is mounted while the insulation is filled inside the door by opening to the outside of the door.
